(19) United States
(12) Patent Application Publication
(10) Pub. No.: US 2010/0245254 A1
(43) Pub. Date: Sep. 30, 2010

(54) Planar Suspension Of A Haptic Touch Screen

(75) Inventors: Neil T. Olien, Montreal (CA); Allan Visitacion, Fremont, CA (US); Aaron Kapelus, Montreal (CA)

Correspondence Address: MEDLER FERRO PLLC, 8607 ROCKDALE LANE, SPRINGFIELD, VA, 22153, US

(73) Assignee: Immersion Corporation, San Jose, CA (US)

(21) Appl. No.: 12/409,593

(22) Filed: Mar. 24, 2009

(51) Int. Cl. G06F 3/041

(52) U.S. Cl. 345/173

(57) ABSTRACT

A planar suspension of a haptic touch screen (or other haptic touch element) is disclosed wherein a haptic touch screen display within an electronic device has a generally planar top surface, a generally planar bottom surface, and edges extending between the top and bottom surfaces. A support structure at least partially surrounds the touch screen within the device and is outboard of and spaced from the edges of the touch screen. Compliant suspension elements are fixed to and extend between the edges of the touch screen and the support structure to suspend the touch screen movably from the outboard support structure. The suspension elements preferably are no thicker than the thickness of the touch screen. Relatively thin compliant backing elements are disposed between the bottom surface of the touch screen and an underlying support structure and a sealing element preferably is disposed between the periphery of the top surface and a surrounding bezel. The planar suspension allows for a substantially thinner overall dimension of the touch screen display and suspension assembly while isolating haptic effects to the screen and providing the feel of a rigidly mounted screen when the screen is pressed.

### TECHNICAL FIELD

This disclosure relates generally to touch screens and more particularly to haptic touch screens and the compliant suspension of haptic touch screens within a device.

### BACKGROUND

New generation consumer devices increasingly rely on touch screen inputs such as virtual buttons and sliders displayed on a screen as an alternative to physical inputs. User's may interface with such devices almost exclusively by touching and/or otherwise manipulating the virtual buttons, sliders, scrollers, and the like on the screen with the fingers. Graphic displays on the screen provide visual feedback responsive to such manipulation. In some more recent touch screen devices, force feedback or tactile feedback, commonly known as haptic feedback, can also be provided to a user as the user's fingers interact with virtual objects on the touch screen. This is accomplished generally by moving or vibrating the screen with a haptic actuator coupled to the screen. To allow the haptic touch screen to move in response to the haptic actuator and thereby to isolate a haptic effect to the screen, haptic touch screens have been compliantly suspended within electronic devices in which they reside. It is important, however, that, even though the screen must be able to move when the haptic actuator is activated, the suspended screen must nevertheless feel to a user as if it were substantially rigidly mounted when touched. Others have addressed the problem by not using a suspension. Not using a suspension limits the mass of the system that can have haptic effects. Normal suspensions, one of which is illustrated in U.S. patent publication number 2008/0111788 A1 of Rosenberg et al, owned by the assignee of the present invention, require relatively thick more compliant suspension materials such as springs or foam to be used under and perhaps over the screen. These suspensions, however, result in a screen assembly that is relatively thick and that can make the screen feel as though it is not rigidly mounted. A need exists for an improved suspension system for a haptic touch screen. The present disclosure is directed to such a suspension system.

### SUMMARY

Briefly described, the present disclosure, in a preferred embodiment thereof, comprises a haptic touch screen (or other touch surface or touch element) that is compliantly supported around its edges by suspension elements such as silicone foam or other spring elements. The suspension elements are referred to herein as “planar” since they are substantially coextensive with the plane of the touch screen to suspend the screen around its edges rather like the spring suspension of a trampoline. The suspension elements can be compressed to fit substantially within the thickness profile of the screen while still allowing compliance in the vertical direction. Other compliant materials and/or seals, much thinner than that used in normal suspensions, can be used above and below the touch screen. These thinner compliant materials can have non-linear spring rates or damping coefficients such that they prevent the touch screen from moving significantly when the screen is pressed by a user, thus making the screen feel substantially rigidly mounted. The planar suspension of the present disclosure thus results in a significantly thinner touch screen assembly that provides the desired isolation of haptic effects to the touch screen while the screen nevertheless feels substantially rigidly mounted when touched. These and other aspects, features, and advantages of the planar suspension disclosed herein will be better understood upon review of the detailed description set forth below when taken in conjunction with the accompanying drawing figures, which are briefly described as follows.

### BRIEF DESCRIPTION OF THE DRAWINGS

FIG. 1 is a plan view of an electronic device having a touch screen that embodies the planar suspension of the present disclosure

FIG. 2 is a cross-sectional view of a section of a prior art “normal” haptic touch screen suspension system with suspension elements above and below the screen.

FIG. 3 is a cross-sectional view of a planar suspension of a haptic touch screen that embodies principles of the present disclosure in one preferred form.

FIG. 4 is a graph illustrating normal suspension (Z axis) compressions from 5-25% for constant planar suspension (XY axis) compressions of 5, 10, 20, and 25%.

FIG. 5 is a graph illustrating planar suspension (XY axis) compression from 5-25% for constant planar suspension (Z axis) compressions of 5, 10, 20, and 25%.

FIG. 6 is a chart comparing a touch screen with and without planar suspension elements.

### DETAILED DESCRIPTION

The invention will be described below within the context of a touch screen wherein a graphical display is disposed behind a touch surface or touch element. It will be understood, however, that the invention is not limited to suspensions for such touch screens but is equally applicable to any haptically excited touch surface or touch element. For example, the invention might be applied to suspend the touch pad of a computer wherein the display screen is not co-located with the touch pad. It may be applied to suspend a touch element with at least one touch sensitive region or an array of touch sensitive regions that may be created by capacitive sensors, near field effect sensors, piezo sensors, or other sensor technology. The graphical element may be a display located behind or in a separate location from the touch element and updated by a host computer, or it may simply be a plastic surface with features (e.g. graphics) indicating touch sensitive regions of an associated touch element. Thus, the term touch screen when used in the following detailed description and in the claims should be construed to encompass traditional touch screens as well as any touch element and associated graphical element to which haptic effects may be applied.

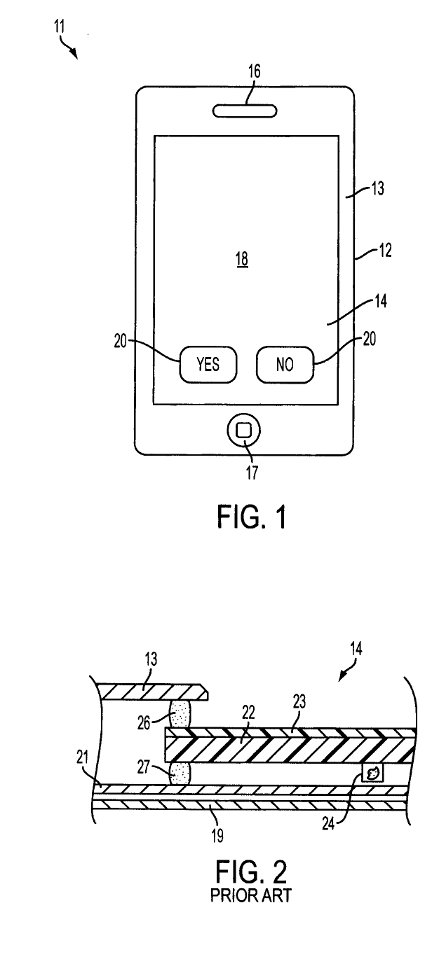

Referring now in more detail to the drawing figures, wherein like reference numerals indicate like parts throughout the several views, FIG. 1 illustrates an electronic device that embodies the screen suspension of the present disclosure. The device may be any of a number of devices such as, for instance, a cellular telephone, PDA, portable gaming device, media player, a printer, an office telephone, or the like. In any event, the electronic device 11 generally comprises a case 12 formed with a bezel 13 that surrounds and frames a haptic touch screen 14. The haptic touch screen 14 can display a graphical environment 18 based on application programs and/or operating systems that are running, such as a graphical user interface (GUI). The graphical environment 18 can include, for example, backgrounds, windows, data listings, a cursor, icons such as buttons 20, and other graphical objects well known in GUI environments. A user interacts with the device by touching various regions of the screen to activate, move, flip, advance, or otherwise manipulate the virtual graphical objects displayed on the screen, and thereby to provide inputs to the device. Such touch screens and GUIs are well know, as exemplified in U.S. published patent application 2008/0111788 A1, incorporated by reference.

The touch screen 14 of the device 11 also is a haptic touch screen in that it is provided with a haptic actuator, described in more detail below, and associated control hardware and software that provides signals to the actuator causing it to induce desired motion of the touch screen in coordination with the user's touches. A signal may be provided to, for example, induce a jolt in conjunction with a virtual button press or collisions between virtual elements, or vibrations in conjunction with movement of virtual elements across the screen, or other types of screen movements as described in more detail in the published patent application incorporated above. Interaction between the user and the electronic device 11 is thereby enhanced through tactile feedback provided by the haptic effects.

FIG. 2 illustrates, in partial cross-section, a typical prior art technique for suspending a haptic touch screen within an electronic device such as the device 11 of FIG. 1. The touch screen 14 generally comprises a graphic display 22 with an overlying touch screen 23 having appropriate tactile sensors, such as capacitive sensors, to detect the touch of a user and convey the x-y position of the touch to the device's controller. A haptic actuator 24 is mounted to or otherwise coupled to the screen 14 and, when activated with an appropriate signal, imparts a desired motion to the screen. The haptic actuator may be any of a number of known actuator types including, without limitation, a voice coil actuator, an eccentric mass actuator, an E-core type actuator, a solenoid, a moving magnet actuator, or other type of actuator as desired.

The haptic touch screen 14 is mounted within the case of a device and, in FIG. 2, the case has a case back 19 and a bezel 13 that frames and partially overlies the edge portions of the haptic touch screen as shown. A printed circuit board 21 typically is mounted within the device adjacent the case back 19 underlying and spaced from the haptic touch screen 14. A top or bezel sealing and suspension element 26 is disposed between the bezel and the edge portion of the touch screen to provide compliant suspension of the screen from above. Similarly, a bottom or screen backing suspension element 27 is disposed between the printed circuit board 21 and the edge portion of the touch screen to provide support of the screen from below. The suspension elements 27 can be of various types including, for instance, coil springs, leaf springs, foam, silicone foam, flexures, or other types of compliant suspensions. Regardless of the type, the effective spring rate of the suspension is determined by compression and extension of the foam or springs, which can be limiting in many cases. Further, this prior art suspension technique necessarily results in a greater packaging thickness since the suspension elements extend upwardly and downwardly respectively from the top and bottom of the haptic touch screen.

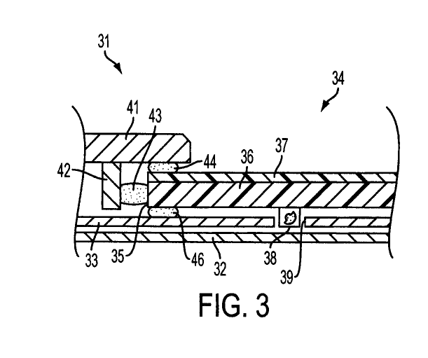

FIG. 3 illustrates a planar suspension of a haptic touch screen according to the present disclosure. An electronic device 31 includes, in this example, a haptic touch screen 34 comprising a graphic display 36 and a touch screen 37 overlying the graphic display 36. The touch screen 37 has appropriate tactile sensors, such as capacitive sensors, to detect the touch of a user and convey the x-y position of the touch to the device's controller. The haptic touch screen 34 is disposed within the case of electronic device 31 overlying and spaced from a printed circuit board 33. The case includes a back 32 and a bezel 41, which frames and overlies a peripheral edge portion of the haptic touch screen 34. A support structure 42 depends from the bezel and is sized and located so that it is disposed outboard and spaced from the edges 35 of the haptic touch screen 34. The support structure can be continuous so that it substantially surrounds the haptic touch screen 34, or it can comprise several discrete segments spaced from the edges of the screen at strategic locations. Further, the support structure need not be part of or attached to the bezel. It may, for example, project inwardly from the side edges of the case, upwardly from the back of the case, or otherwise, all within the scope of the disclosure.

A main suspension element 43 extends between and compliantly couples together the edge 35 of the haptic touch screen 34 and the support structure 42. The main suspension element may extend continuously around the edge of the haptic touch screen 34, but more preferably is comprised of a number of discrete suspension elements extending between the screen edges and support structures at strategic locations. In one example, described in more detail below, eight (8) suspension elements in the form of foam sections are used, two along each edge and substantially at the corners of the haptic touch screen. Each foam section is 0.15 inch wide in a direction extending away from the screen edge, 0.5 inch long in a direction extending along the screen edge, and 0.1 inch thick. While this configuration is considered a best mode for carrying out the invention, other sizes and configurations of the main suspension element or elements 43 may well be substituted with equivalent results. Further, main suspension elements may be provided along only two opposed edges if desired rather than along all four edges, or indeed along any edge or combination of edges as required, all within the scope of the invention.

A top or bezel sealing element 44 is disposed between the bezel and the edge portion of the screen to provide a dust seal. The bezel sealing element may be made of traditional sealing foams, or may take other forms such as a rubber wiper since a hermetic seal is generally not required. A bottom screen backing element (or several elements) are provided between the printed circuit board 33 and the back of the haptic touch screen 34. The bottom screen backing element or elements provide, among other things, a stop that prevents the haptic touch screen from impacting the printed circuit board 33, which otherwise would cause impact noise when the screen was pressed by a user. These elements can be made of other compliant materials with non-linear spring rates such that they prevent the screen from traveling significantly when pressed by a user. The user is thus presented the feel of a rigidly mounted screen when the screen is pressed. Because of the thinner profile of the suspension, FIG. 3 shows an opening 39 formed in the printed circuit board 33 to accommodate the haptic actuator 38, which, in this embodiment, is mounted to the back surface of the touch screen 34.

It will be appreciated from the forgoing that, according to the present disclosure, a haptic touch screen is suspended by planar main suspension elements extending from edges of the touch screen to a support structure spaced from the edges. Since the main spring rate is determined by the shear of the compliant suspension elements around the edges, little or no thickness beyond the thickness of the haptic touch screen itself is required for the main suspension. Overall packaging height can thus be significantly decreased resulting in thinner electronic devices. While a small increased thickness is needed to insure that the surface of the screen can move laterally and to accommodate the very thin foam sealing and backing elements 44 and 46 for sealing and preventing impact noise, this increased thickness is small compared to prior art suspensions. Further, the use of thin foams allows rigid features to be placed close to the back of the screen to create a stop that limits how far the screen can be displaced by a user when touching the screen. This, in turn, gives the user the experience of a rigidly mounted screen. Accordingly, planar suspension of the present disclosure represents a distinct advance over prior art suspension systems.

### Example and Test Results

To test and help optimize a planar suspension constructed according to the present invention, a test was designed and carried out to determine the effect on acceleration of a haptically excited screen of the compression of the compliant materials supporting the screen. A 4.5 inch touch screen was mounted within a 6 inch articulating test frame with foam suspension elements disposed between the edges of the screen and the test frame. A total of 4 suspension elements were mounted to and supported the frame in the X planar direction, two each on opposite sides of the screen and located adjacent the corners of the screen. Each suspension element was approximately 0.5 inch long and 0.15 inch wide. The same suspension configuration was used to support the edges of the screen in the Y direction; i.e. four foam suspension elements mounted to opposite edges of the frame adjacent the corners of the screen. To support the screen in the Z direction (the direction normal to the plane of the screen), eight foam suspension elements, each 0.25 inch long, were mounted to the front and back of the screen at its edges with four elements on the front adjacent the screen corners and four on the back at the screen corners. All of the foam suspension elements were R10480 foam material that was 0.1 inch thick. Thus, the test screen was suspended within the test frame with the suspension elements as described. The test frame is articulated in that it has the ability to be controllably expanded and contracted in the X, Y, and Z directions in order to impart a desired and measurable amount of compression to the suspension elements in either or a combination of directions

A Sanyo® NRS 2574I haptic actuator was mounted to the back surface of the test screen and coupled to an actuator control board programmed to excite the actuator and thus the screen with various haptic effects. An accelerometer was attached to the front surface of the screen at its center to detect the acceleration of the screen along all three axes when the screen was stimulated by the haptic actuator. The accelerometer was then coupled to a digital oscilloscope with the capacity to display and capture the peak-to-peak accelerations in the X, Y, and Z axes directions detected by the accelerometer. The test and data collection was then carried as in the following manner.

First, the compression of suspension elements in the XY axis directions (in the plane of the screen) was set and held at constant values of 5, 10, 20, and 25 percent using the articulated test frame. For each of these constant compressions, the compression of the eight suspension elements in the Z direction was varied from 5 to 25 percent in increments of 5 percent, using the frame. For each of the resulting sixteen combinations, the peak-to-peak accelerations of the screen in the X, Y, and Z directions were measured as the screen was haptically excited by the haptic actuator. The sum of the squares of these measurements was then recorded as a measure of the magnitude of screen movement for each combination of suspension element compression. Screen movement of greater magnitudes is more desirable, and this stage of the test provided an indication of the effect on screen movement of varying the compression of the suspension elements in the planar or X and Y directions.

Second, the compression of suspension elements in the Z axis direction (normal to the screen of the plane) was set and held at constant values of 5, 10, 20, and 25 percent using the test frame. For each of these constant compressions, the compression of the eight suspension elements in the planar or XY axis directions were varied from 5 to 25 percent in increments of 5 percent. For each combination, the accelerations in each axis were measured, squared, and summed as a measure of the magnitude of screen movement. This stage of the test thus provided an indication of the effect on screen movement of varying the compression of the suspension elements in the normal or Z axis direction. Table 1 below summarized the results of the two test conditions.

TABLE 1
Comparison of Peak to Peak Accelerations vs. Normal Z Axis Compression
and Peak to Peak Accelerations vs. Planar XY Axis Compression

| Compression | | Total | Compression | | Total |
|---|---|---|---|---|---|
| (in %) | | Peak to Peak | (in %) | | Peak to Peak |
| Planar XY | Normal Z | Accelerations (in Gs) | Normal Z | Planar XY | Accelerations (in Gs) |
| 5.00 | 5.00 | 7.97 | 5.00 | 5.00 | 7.97 |
| 5.00 | 10.00 | 8.41 | 5.00 | 10.00 | 7.99 |
| 5.00 | 20.00 | 9.53 | 5.00 | 20.00 | 7.76 |
| 5.00 | 25.00 | 10.08 | 5.00 | 25.00 | 8.12 |
| Maximum Difference | | 2.11 | Maximum Difference | | 0.37 |
| % Difference from Ave | | 23.45 | % Difference from Ave | | 4.62 |
| 10.00 | 5.00 | 7.99 | 10.00 | 5.00 | 8.41 |
| 10.00 | 10.00 | 9.38 | 10.00 | 10.00 | 9.38 |
| 10.00 | 20.00 | 10.26 | 10.00 | 20.00 | 9.51 |
| 10.00 | 25.00 | 10.53 | 10.00 | 25.00 | 9.06 |
| Maximum Difference | | 2.53 | Maximum Difference | | 1.10 |
| % Difference from Ave | | 26.57 | % Difference from Ave | | 12.09 |
| 20.00 | 5.00 | 7.76 | 20.00 | 5.00 | 9.53 |
| 20.00 | 10.00 | 9.51 | 20.00 | 10.00 | 10.26 |
| 20.00 | 20.00 | 10.29 | 20.00 | 20.00 | 10.29 |
| 20.00 | 25.00 | 11.59 | 20.00 | 25.00 | 10.66 |
| Maximum Difference | | 3.83 | Maximum Difference | | 1.13 |
| % Difference from Ave | | 39.18 | % Difference from Ave | | 11.09 |
| 25.00 | 5.00 | 8.12 | 25.00 | 5.00 | 10.08 |
| 25.00 | 10.00 | 9.06 | 25.00 | 10.00 | 10.53 |
| 25.00 | 20.00 | 10.66 | 25.00 | 20.00 | 11.59 |
| 25.00 | 25.00 | 11.73 | 25.00 | 25.00 | 11.73 |

| | | | |
|---|---|---|---|
| Maximum Difference | 3.60 | Maximum Difference | 1.65 |
| % Difference from Ave | 36.43 | % Difference from Ave | 15.03 |

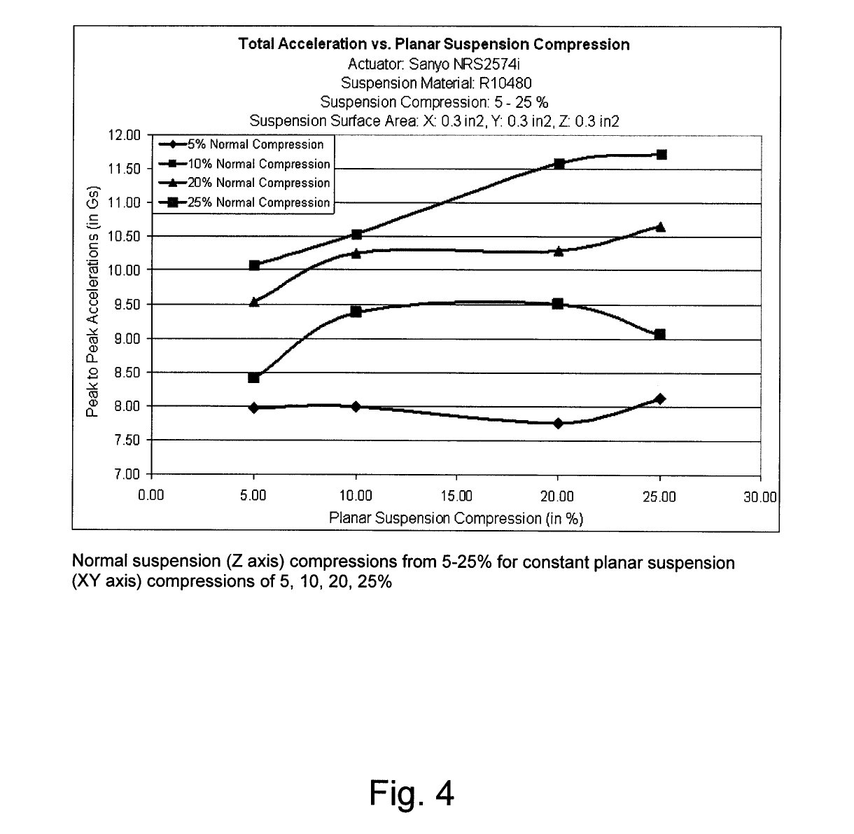

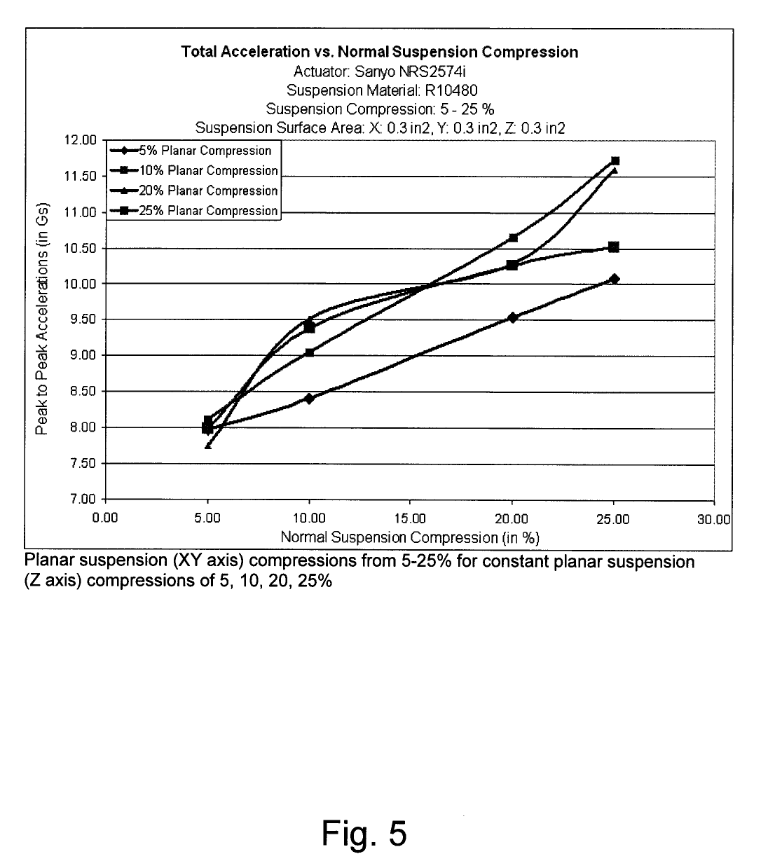

In table 1, for each test set, the maximum difference, which is the difference between the largest data point and the smallest, was calculated as was the percent that this value deviated from the average of the data points. The larger these two parameters, the greater the magnitude of the movement of the screen under haptic stimulation. The smaller, the less the magnitude of the movement. It can thus be seen from this table that the magnitude of screen movement is much more influenced by compression of the suspension elements in the normal or Z direction than by compression of the suspension elements in the planar or X and Y directions. This type of information can be important to designers of electronic devices because it dictates tolerances to which the device must be held in order to produce optimum results. We know from the forgoing test, for example, that tolerances of the frame and screen in the planar direction may not need to be as tight as tolerances in the normal direction. The above data also may be presented in the graphs shown in FIGS. 4 and 5.

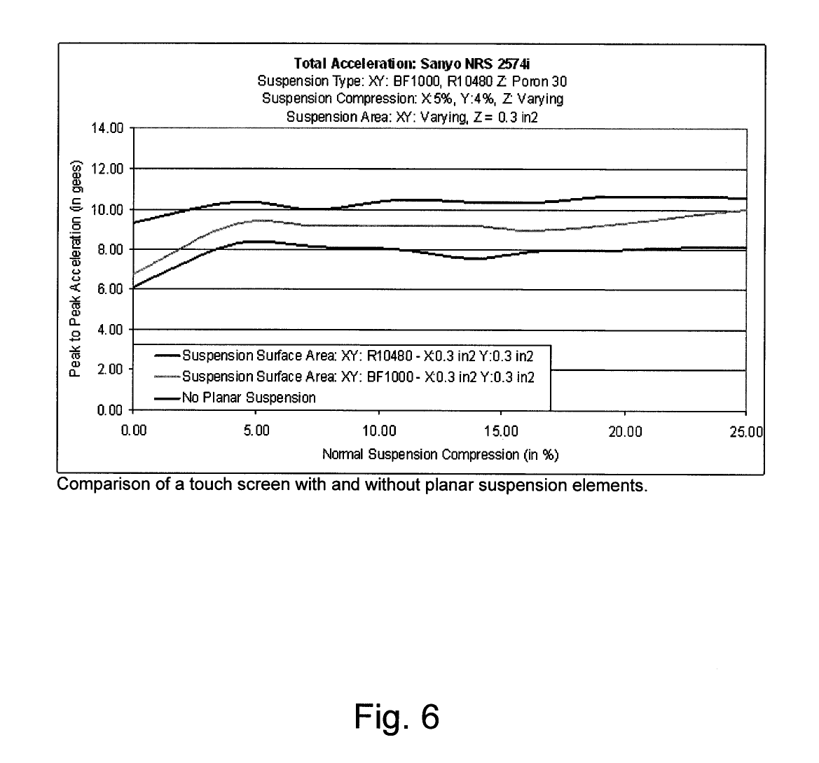

The graph depicted in FIG. 6 compares performance (as indicated by peak to peak acceleration under haptic excitement) as compression in the normal direction is increased for a Poron 30 touch screen with and without the addition of a planar suspension system according to this disclosure. The bottom line in this graph indicates performance with no planar suspension, the intermediate line indicates performance with a planar suspension composed of BF 1000 material, and the top line indicates performance with a planar suspension composed of R0480 material. This graph shows clearly that adding planar suspension elements to a touch screen (or other touch element) increases the peak to peak acceleration of the screen under the influence of a haptic actuator for the entire range of normal suspension compressions.

The invention has been described herein in terms of preferred embodiments and methodologies considered by the inventors to represent the best mode of carrying out the invention. It will be understood, however, that various additions, deletions, and modifications may be made to the embodiments illustrated herein within the scope of the invention. For example, while a particular suspension foam and a particular actuator have been identified in connection with the example and test above, other suspension materials and other types of actuators may be used as desired. Further, while in the preferred embodiment, the screen was suspended with a balanced configuration of a total of 16 suspension elements (8 planar suspension elements and 8 normal suspension elements), other numbers and configurations of suspension elements are possible and within the scope of the invention. Finally, as mentioned above, the invention is not limited to the suspension of touch screens, but is equally applicable to the suspension of any touch element to which haptic effects may be applied. These and other modifications to the illustrated embodiments might well be made without departing from the spirit and scope of the invention as set forth in the claims.

What is claimed is:

1. A touch screen assembly comprising:
a display;
a touch screen overlying the display;
the display and touch screen together having a generally planar upper surface, a generally planar lower surface, and peripheral edges extending between the upper and lower surfaces;
a support structure at least partially surrounding the display and touch screen outboard of the edges; and
at least one compliant suspension element connecting at least one edge of the display and touch screen to the support structure for movably suspending the display and touch screen.

2. A touch screen assembly as claimed in claim 1 and further comprising a plurality of compliant suspension elements connecting at least two edges of the display and touch screen to the support structure.

3. A touch screen assembly as claimed in claim 1 and wherein the compliant suspension element is disposed between the planes of the upper and lower surfaces.

4. A touch screen assembly as claimed in claim 1 and wherein the compliant suspension element comprises a spring.

5. A touch screen assembly as claimed in claim 1 and wherein the compliant suspension element comprises a compliant polymer.

6. A touch screen assembly as claimed in claim 1 and wherein the compliant suspension element comprises a compliant foam.

7. A touch screen assembly as claimed in claim 6 and wherein the compliant foam is a silicone foam.

8. A touch screen assembly as claimed in claim 1 and further comprising a bottom support structure underlying and spaced from the lower surface of the display and touch screen and a compliant bottom screen backing element disposed between the lower surface of the display and touch screen and the bottom support structure.

9. A touch screen assembly as claimed in claim 8 and further comprising a bezel at least partially surrounding and overlying a peripheral portion of the upper surface of the display and touch screen and a bezel sealing element disposed between the bezel and the upper surface of the display and touch screen.

10. A touch screen assembly as claimed in claim 8 and wherein the bottom support structure is a printed circuit board.

11. A method of suspending a planar touch screen having a bottom surface, a top surface, and edges, the method comprising
(a) locating an edge support structure outboard of and spaced from at least one edge of the touch screen; and
(b) disposing at least one compliant suspension element between the at least one edge and the edge support structure.

12. The method of claim 11 and further comprising locating a bottom support structure beneath and spaced from the bottom surface of the touch screen and disposing at least one compliant bottom screen backing element between the bottom surface of the touch screen and the bottom support structure.

13. The method of claim 11 and further comprising locating a bezel around and overlying a peripheral portion of the upper surface of the touch screen and disposing a bezel sealing element between the bezel and the upper surface of the touch screen.

14. An electronic device comprising:
a case;
a touch screen display having edges and being disposed within the case;
a support structure at least partially surrounding the touch screen display outboard of and spaced from an edge of the touch screen display; and
a compliant suspension element disposed between and connecting the edge of the touch screen display and the support structure.

15. The electronic device of claim 14 and wherein the compliant suspension element is a spring.

16. The electronic device of claim 14 and wherein the compliant suspension is a compliant polymer.

17. The electronic device of claim 14 and wherein the compliant suspension is a foam.

18. The electronic device of claim 17 and wherein the foam is a silicone foam.

19. The electronic device of claim 14 and wherein the touch screen display has a bottom surface and further comprising a bottom support structure beneath and spaced from the bottom surface of the touch screen display and at least one screen backing element disposed between the bottom surface of the touch screen and the bottom support structure.

20. The electronic device of claim 19 and wherein the bottom support structure is a printed circuit board.

21. The electronic device of claim 14 and wherein the touch screen display has a top surface and further comprising a bezel surrounding and overlying a peripheral portion of the top surface of the touch screen display and a sealing element disposed between the bezel and the top surface of the touch screen display.

22. A touch screen display assembly comprising:
a touch screen display having edges and a thickness;
a support structure disposed outboard of and spaced from at least one edge of the touch screen display; and
a compliant suspension element having a thickness no greater than the thickness of the touch screen display and being disposed between the at least one edge of the touch screen display and the support structure to suspend the touch screen display movably from the support structure.

23. A touch screen display assembly as claimed in claim 22 and wherein the support structure at least partially surrounds the touch screen display outboard of and spaced from its edges and wherein a plurality of compliant suspension elements having thicknesses no greater than the thickness of the touch screen display are disposed between edges of the touch screen display and the support structure.

24. An interactive device comprising:
a touch element having peripheral edges;
a graphical element associated with the touch element;
a support structure at least partially surrounding the touch element outboard of the peripheral edges; and
at least one compliant suspension element connecting at least one peripheral edge of the touch element to the support structure for movably suspending the touch element.

25. The interactive device of claim 24 and wherein the graphical element is a graphic display updatable by a host computer.

26. The interactive device of claim 25 and wherein the graphic display is located behind the touch element.

27. The interactive device of claim 24 and wherein the touch element has touch sensitive regions.

28. The interactive device of claim 27 and wherein the graphical element is a surface with features indicating the touch sensitive regions.

29. The interactive device of claim 28 and wherein the surface is substantially co-located with the touch element.
